(19) United States
(12) Patent Application Publication
(10) Pub. No.: US 2010/0155172 A1
(43) Pub. Date: Jun. 24, 2010

(54) HYDRAULIC POWER STEERING APPARATUS

(75) Inventors: Sung-moo HEO, Wonju (KR); Byung-yun CHOI, Wonju (KR); Jong-sik BYEON, Wonju (KR); Hyoung-woo KIM, Wonju (KR); Heung-ju KIM, Wonju (KR)

Correspondence Address: HARNESS, DICKEY & PIERCE, P.L.C., P.O. BOX 828, BLOOMFIELD HILLS, MI, 48303, US

(73) Assignee: MANDO CORPORATION, Wonju-si (KR)

(21) Appl. No.: 12/646,472

(22) Filed: Dec. 23, 2009

(30) Foreign Application Priority Data
Dec. 24, 2008 (KR) 10-2008-0133727

(51) Int. Cl. B62D 5/12

(52) U.S. Cl. 180/432

(57) ABSTRACT

A hydraulic power steering apparatus for a vehicle is disclosed. The hydraulic power steering apparatus for a vehicle forms a working fluid film between a piston reciprocating within a cylinder tube and a piston ring in order to provide an accurate auxiliary steering force by preventing leakage of a working fluid between right and left cylinders during the operation of a steering wheel by the driver.

### BACKGROUND OF THE INVENTION

1. Field of the Invention

The present invention relates to a hydraulic power steering apparatus for a vehicle, and more particularly to a hydraulic power steering apparatus for a vehicle that forms a working fluid film between a piston reciprocating within a cylinder tube and a piston ring in order to provide an accurate auxiliary steering force by preventing leakage of a working fluid between right and left cylinders during the operation of a steering wheel by the driver.

2. Description of the Prior Art

As generally known in the art, a steering apparatus is provided between a driver's seat and wheels to allow the driver to move the wheels, and includes a steering shaft provided under the steering wheel of the driver, a pinion valve assembly connected to the steering shaft, and a rack bar extending to the right and left sides and connected to the wheels to directly operate the wheels during the operation of the pinion valve assembly.

FIG. 1 is a partially sectional view of a conventional hydraulic power steering apparatus for a vehicle.

As illustrated in FIG. 1, a pinion valve assembly 125 to which a hydraulic pump 130 is connected is provided under a steering wheel 110 and a steering shaft 115.

The pinion valve assembly 125 is adapted to control the oil supplied through the oil pump 130, and an input shaft 120 connected to the steering shaft 115 to receive the rotational force generated by the steering wheel 110 is provided on the upper side of the interior of the pinion valve assembly 125.

A pinion (not shown) rotated by the rotational force transmitted through the input shaft 120 and in which teeth are formed on the outer peripheral portion of an end thereof is provided on the lower side of the interior of the pinion valve assembly 125 and a rack housing 135 integrally formed with the pinion valve assembly 125 and extending in opposite directions is provided outside a lower portion of the pinion valve assembly 125.

A cylinder tube 137 is press-fitted with the rack housing 135 on one side of the rack housing 135, and the cylinder tube 137 is an open-ended hollow tube for defining a space through which the oil supplied through the pinion valve assembly 125 flows. An oil seal 170, a rack bush 160, a rack stopper 165, and the like are installed on one side of the opened inlet of the cylinder tube 137, and a bellows 150 is installed on the outer peripheral side of the cylinder tube 137, and an oil seal 170 is installed on the opposite side of the opened inlet of the cylinder tube 137.

A rack bar 140 having a rack at its middle portion to enmesh with a pinion provided in the pinion valve assembly 125 is provided within the rack housing 135.

The rack bar 140 is adapted to be axially moved within the rack housing 135 and a rack is formed at a middle portion of the rack bar 140 to enmesh with the pinion of the pinion valve assembly 125. The right and left sides of the rack bar 140 are connected to tie rods 155 by the medium of inner ball joints in which balls are inserted within ball housings 175 to steer the wheels.

A piston 145 is provided on one side of the rack bar 140 so as to be attached to and slid on the inner surface of the cylinder tube 137 and an O-ring 143 is coupled to the outer surface of the piston 145. The piston 145 is installed between two hydraulic pipes connected to the pinion valve assembly 125 to be operated by the hydraulic pressure supplied through the pinion valve assembly 125.

Meanwhile, the rack bush 160 is provided on one side of the open-ended cylinder tube 137 to guide movement of the rack bush 140, and the oil seal 170 is installed on the opposite side of the cylinder tube 137.

The rack bush 160 is hollowed such that its outer peripheral surface is attached to and fixed to the inner peripheral surface of the cylinder tube 137 and its inner peripheral surface 160 is attached to the outer peripheral surface of the rack bar 140 inserted into the hollowed rack bush 160 so as to guide the slide of the rack bar 140.

However, in the conventional hydraulic power steering apparatus, when the piston connected to the rack bar reciprocates within the cylinder tube to the right and left sides by the hydraulic pressure of the working fluid during the operation of the steering wheel by the driver, the working fluid is leaked to the right and left cylinders between the piston and the cylinder tube, causing the working fluid to be continuously supplied from the hydraulic pump.

Moreover, if an auxiliary steering force cannot be provided during the operation of the steering wheel by the driver due to leakage of the working fluid, a strong or excessively weak force needs to be applied to the steering wheel by the driver.

### SUMMARY OF THE INVENTION

Accordingly, the present invention has been made to solve the above-mentioned problems occurring in the prior art, and an object of the present invention is to provide a hydraulic power steering apparatus for a vehicle that forms a working fluid film between a piston reciprocating within a cylinder tube and a piston ring in order to provide an accurate auxiliary steering force by preventing leakage of a working fluid between right and left cylinders during the operation of a steering wheel by the driver.

In order to accomplish this object, there is provided a hydraulic power steering apparatus for a vehicle including: a cylinder tube having a right cylinder and a left cylinder into which a working fluid is supplied and in which a rack bar linearly reciprocates; a piston moving the rack bar to the right and left sides using the hydraulic pressure of the working fluid supplied into the cylinder tube, in which the rack bar is coupled to an inner peripheral portion thereof and a plurality of slits formed by cutting one side surface and portions of the outer peripheral portion thereof are formed on one side thereof; and a piston ring mounted on the outer peripheral portion of the piston and inserted into the inner peripheral surface of the cylinder tube.

In accordance with another aspect of the present invention, there is provided a hydraulic power steering apparatus for a vehicle including: a cylinder tube having a right cylinder and a left cylinder into which a working fluid is supplied and in which a rack bar linearly reciprocates; a piston moving the rack bar to the right and left sides using the hydraulic pressure of the working fluid supplied into the cylinder tube in which the rack bar is coupled to an inner peripheral portion thereof; and a piston ring mounted on the outer peripheral portion of the piston and inserted into the inner peripheral surface of the cylinder tube, the piston ring having a plurality of working fluid introducing holes radially formed such that the outer peripheral portion of the piston is communicated with the inner peripheral surface of the cylinder tube.

According to the present invention, a hydraulic power steering apparatus for a vehicle forms a working fluid film between a piston reciprocating within a cylinder tube and a piston ring in order to provide an accurate auxiliary steering force by preventing leakage of a working fluid between right and left cylinders during the operation of a steering wheel by the driver.

### BRIEF DESCRIPTION OF THE DRAWINGS

The above and other objects, features and advantages of the present invention will be more apparent from the following detailed description taken in conjunction with the accompanying drawings, in which:

FIG. 1 is a partially sectional view of a conventional hydraulic power steering apparatus for a vehicle;

FIG. 2 is a sectional view illustrating a portion of a hydraulic power steering apparatus for a vehicle according to the first embodiment of the present invention;

FIG. 3 is a perspective view illustrating the operational state of a check valve of the hydraulic power steering apparatus of FIG. 2;

FIG. 4 is a sectional view illustrating a portion of a hydraulic power steering apparatus for a vehicle according to the second embodiment of the present invention; and

FIG. 5 is a perspective view illustrating the operational state of a check valve of the hydraulic power steering apparatus of FIG. 4.

### DETAILED DESCRIPTION OF THE PREFERRED EMBODIMENTS

Hereinafter, preferred embodiments of the present invention will be described with reference to the accompanying drawings. In the following description and drawings, the same reference numerals are used to designate the same or similar components, and so repetition of the description on the same or similar components will be omitted.

In the description of the elements of the present invention, the terms ‘first’, ‘second’, ‘A’, ‘B’, ‘(a)’, and ‘(b)’ may be used. However, since the tennis are used only to distinguish an element from another, the essence, sequence, and order of the elements are not limited by them. When it is described that an element is “coupled to”, “engaged with”, or “connected to” another element, it should be understood that the element may be directly coupled or connected to the other element but still another element may be “coupled to’, “engaged with”, or “connected to” the other element between them.

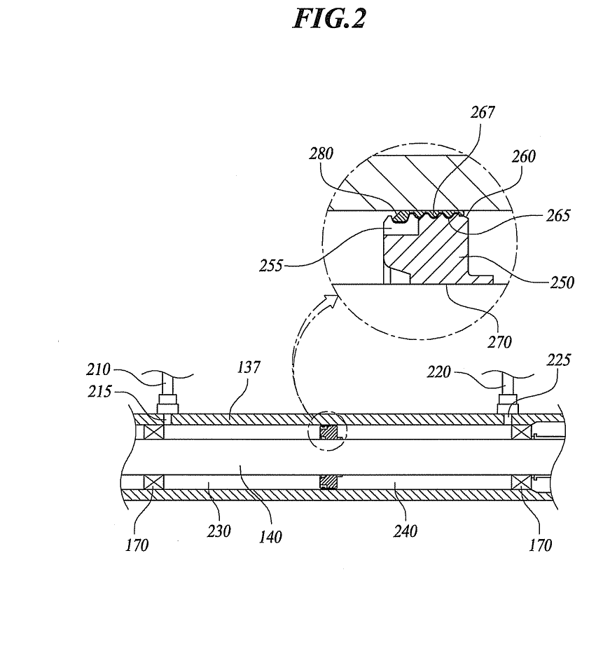

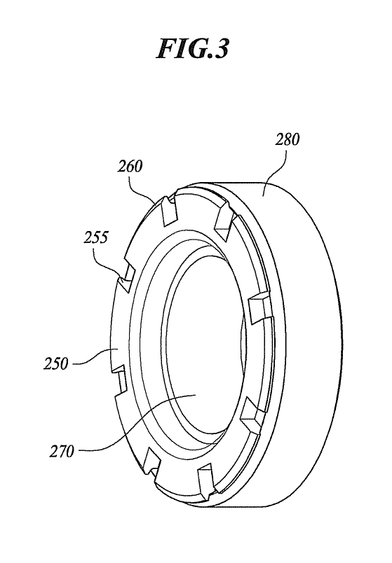

FIG. 2 is a sectional view illustrating a portion of a hydraulic power steering apparatus for a vehicle according to the first embodiment of the present invention. FIG. 3 is a perspective view illustrating a piston of the hydraulic power steering apparatus of FIG. 2.

As illustrated in FIGS. 2 and 3, the hydraulic power steering apparatus for a vehicle according to the first embodiment of the present invention includes a cylinder tube 137 having a right cylinder 240 and a left cylinder 230 into which a working fluid is supplied and in which a rack bar 140 linearly reciprocates; a piston 250 moving the rack bar 140 to the right and left sides using the hydraulic pressure of the working fluid supplied into the cylinder tube 137, in which the rack bar 140 is coupled to an inner peripheral portion thereof and a plurality of slits 255 formed by cutting one side surface and portions of the outer peripheral portion 260 thereof are formed on one side thereof; and a piston ring 280 mounted on the outer peripheral portion 260 of the piston 250 and inserted into the inner peripheral surface of the cylinder tube 137.

A plurality of grooves 265 are radially formed at the outer peripheral portion 260 of the piston 250. The piston ring 280 has bosses 267 corresponding to the grooves 265 of the piston 250. The piston 250 has a plurality of slits 255 formed by cutting an opposite side surface and portions of an outer peripheral portion 260 thereof on a side opposite to the side on which the slits 255 are formed.

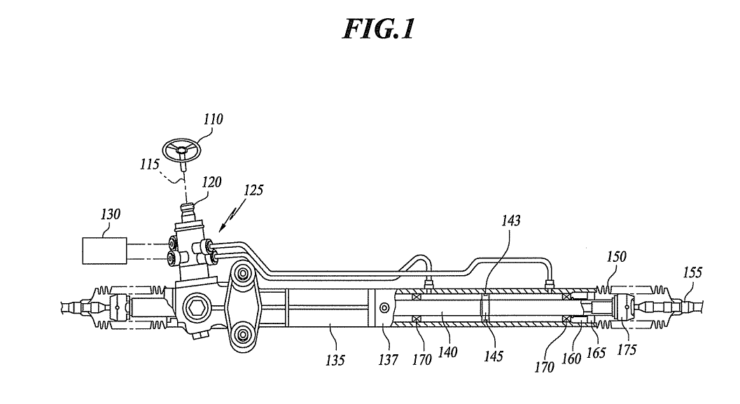

The rack bar 140 converts the rotational movement of the steering wheel 110 (refer to FIG. 1) operated by the driver and reciprocates within the rack housing 135 (refer to FIG. 1) and the cylinder tube 137 along the central axis of the rack bar 140. The right and left ends of the rack bar 140 are connected to the tie rods 155 (refer to FIG. 1) by the medium of inner ball joints in which balls are inserted into the ball housing 175 (refer to FIG. 1) to steer the wheels.

The cylinder tube 137 is divided into the right cylinder 240 and the left cylinder 230 around the piston 250 press-fitted onto the rack bar 140 so that the working fluid is introduced through a right feed tube 220 or a left feed tube 210 from the hydraulic pump 130 (refer to FIG. 1) during the operation of the steering wheel by the driver to reciprocate the rack bar 140 coupled to the piston 250 to the right and left sides within the cylinder tube 137 using the hydraulic pressure of the working fluid.

The piston 250 is coupled to the rack bar 140 on the inner peripheral surface thereof to move the rack bar 140 to the right and left sides using the hydraulic pressure of the working fluid supplied to a right port 225 and a left port 215 of the cylinder tube 137. The piston ring 280 formed of a resilient material such as Teflon or silicon and attached to the cylinder tube 137 is press-fitted onto the outer peripheral surface of the piston 250.

The piston 250 has an annular shape and has an inner peripheral portion 270 and an outer peripheral portion 260. The rack bar 140 is coupled to the inner peripheral portion 270 of the piston 250 and the grooves 265 are recessed in the radial direction of the piston 250 on the outer peripheral portion 260 of the piston 250 so that the piston ring 280 is mounted on the outer peripheral portion 260 of the piston 250.

The slits 255 formed by cutting portions of the outer peripheral portion 260 of the piston 250 toward the inner peripheral portion 270 of the piston 250 on one surface of the piston 250 perpendicular to the central axis of the rack bar 140, so that the working fluid filled in the right cylinder 240 and the left cylinder 230 permeates between the outer peripheral portion 260 of the piston 250 or the grooves 265 of the piston 250 and the piston ring 280 so that the piston ring 280 is floated toward the cylinder tube 137 using the hydraulic pressure of the working fluid to prevent leakage of the working fluid into the right cylinder 240 and the left cylinder 230.

A plurality of slits formed by cutting portions of the outer peripheral portion 260 of the piston 250 toward the inner peripheral portion 270 of the piston 250 may be provided on a side opposite to the side on which the slits 255 is formed.

Here, the slits 255 on the surfaces of the piston 250 may be formed by cutting the outermost grooved portions on the outer peripheral portion 260 of the piston 250.

Although the slits 255 are partially formed from the outer peripheral portion 260 toward the inner peripheral portion 270 of the piston 250 in FIGS. 2 and 3, the present invention is not limited thereto but the slits 255 may be entirely formed from the outer peripheral portion 260 to the inner peripheral portion 270 of the piston 250 according to the amount of the introduced working fluid.

Therefore, since the working fluid is introduced into the grooves 265 through the partially or entirely cut slits 255 to attach the piston ring 280 to the cylinder tube 137 using the hydraulic pressure of the working fluid, it is prevented from being leaked into the right cylinder 240 and the left cylinder 230, thereby allowing an accurate steering force.

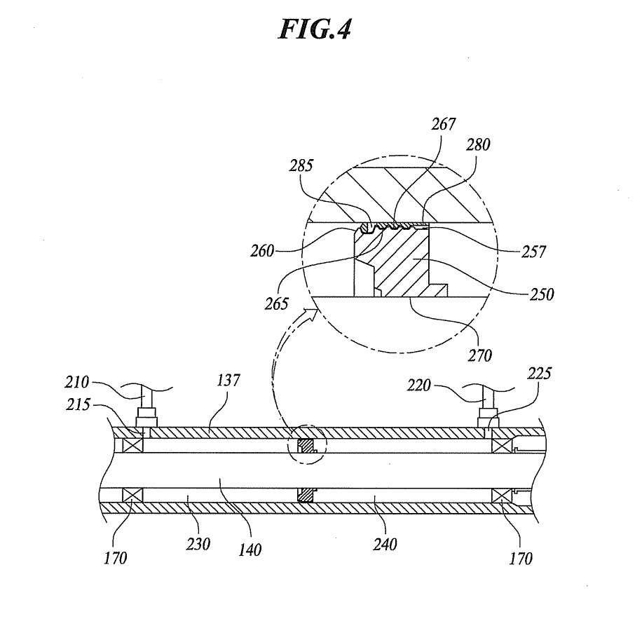

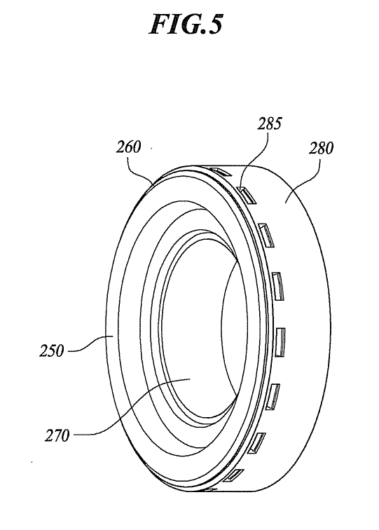

FIG. 4 is a sectional view illustrating a portion of a hydraulic power steering apparatus for a vehicle according to the second embodiment of the present invention. FIG. 5 is a perspective view illustrating a piston of the hydraulic power steering apparatus of FIG. 4.

As illustrated in FIGS. 4 and 5, the hydraulic power steering apparatus for a vehicle according to the first embodiment of the present invention includes a cylinder tube 137 having a right cylinder 240 and a left cylinder 230 into which a working fluid is supplied and in which a rack bar 140 linearly reciprocates; a piston 250 moving the rack bar 140 to the right and left sides using the hydraulic pressure of the working fluid supplied into the cylinder tube 137 in which the rack bar 140 is coupled to an inner peripheral portion thereof; and a piston ring 280 mounted on the outer peripheral portion 260 of the piston 250 and inserted into the inner peripheral surface of the cylinder tube 137, the piston ring 280 having a plurality of working fluid introducing holes 265 radially formed such that the outer peripheral portion of the piston 250 is communicated with the inner peripheral surface of the cylinder tube 137.

In the second embodiment of the present invention, the working fluid is introduced through the working fluid introducing holes 285 formed in the piston ring 280 between the piston 250 and the piston ring 280 to float the piston ring 280 toward the cylinder tube 137 and thus attach the piston ring 280 to the cylinder tube 137.

The rack bar 140 is coupled to the inner peripheral portion 270 of the piston 250 and the grooves 265 are formed in the radial direction of the piston 250 on the outer peripheral portion 260 of the piston 250.

Meanwhile, the piston ring 280 is mounted on the outer peripheral portion 260 of the piston 250 and inserted into the inner peripheral surface of the cylinder tube 137, and the bosses 267 corresponding to the grooves 265 of the piston 250 are provided on the inner peripheral surface of the piston ring 280 to be coupled to the piston 250.

The working fluid introduced through the working fluid introducing holes 285 of the piston ring 280 formed in the radial direction of the piston ring 280 in communication with the groove 265 on the outer peripheral portion 260 of the piston 250 floats the piston ring 280 toward the cylinder tube 137 using its hydraulic pressure.

A plurality of working fluid introducing holes may be formed in the radial direction of the piston ring 280 on a side of the piston ring 280 opposite to the side on which the working fluid introducing holes 285 is formed in communication with the groove 265 on the outer peripheral portion 260 of the piston 250.

The working fluid introducing holes 285 formed on the sides of the piston ring 280 may be formed in the radial direction of the piston ring 280 in communication with the outermost grooved portions on the outer peripheral portion 260 of the piston 250.

Moreover, a slot hole 257 through which the working fluid is introduced into the piston ring 280 and formed on a side of the piston 250 opposite to the side of the piston 250 on which the working fluid introducing hole 285 is formed provides an aperture between the piston 250 and the piston ring 280, allowing the working fluid to form a fluid film.

According to the present invention, a hydraulic power steering apparatus for a vehicle forms a working fluid film between a piston reciprocating within a cylinder tube and a piston ring in order to provide an accurate auxiliary steering force by preventing leakage of a working fluid between right and left cylinders during the operation of a steering wheel by the driver.

Even when all the elements of the embodiments of the invention are combined into one, the invention is not limited thereto. That is, all the elements may be selectively combined with each other without departing the scope the invention.

Also, the phraseology and terminology used herein is for the purpose of description and should not be regarded as limiting. The use of “including”, “comprising”, or “having”, and variations thereof herein, is meant to encompass the items listed thereafter and equivalents thereof as well as additional items. Unless otherwise specifically defined herein, all terms including technical or scientific terms are to be given meanings understood by those skilled in the art. Like terms defined in dictionaries, generally used terms needs to be construed as meanings used in technical contexts and are not construed as ideal or excessively formal meanings unless otherwise clearly defined herein.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. Therefore, the embodiments of the invention are given not to limit but to explain the technical spirit of the invention, and the scope of the invention is not limited by the embodiments. The scope of the invention should be construed by the claims, and the equivalents to the invention are construed as included in the scope of the invention.

This application claims the benefit and priority of Korean Patent Application No. 10-2008-0133727, filed Dec. 24, 2008. The entire disclosure of the above application is incorporated herein by reference.

What is claimed is:

1. A hydraulic power steering apparatus for a vehicle comprising:
a cylinder tube having a right cylinder and a left cylinder into which a working fluid is supplied and in which a rack bar linearly reciprocates;
a piston moving the rack bar to the right and left sides using the hydraulic pressure of the working fluid supplied into the cylinder tube, in which the rack bar is coupled to an inner peripheral portion thereof and a plurality of slits formed by cutting one side surface and portions of the outer peripheral portion thereof are formed on one side thereof; and
a piston ring mounted on the outer peripheral portion of the piston and inserted into the inner peripheral surface of the cylinder tube.

2. The hydraulic power steering apparatus as claimed in claim 1, wherein a plurality of grooves are radially formed at the outer peripheral portion of the piston.

3. The hydraulic power steering apparatus as claimed in claim 2, wherein the piston ring has bosses corresponding to the grooves of the piston.

4. The hydraulic power steering apparatus as claimed in claim 1, wherein the piston has a plurality of slits formed by cutting an opposite side surface and portions of an outer peripheral portion thereof on a side opposite to the side on which the slits are formed.

5. The hydraulic power steering apparatus as claimed in claim 3 or 4, wherein the slits are formed by cutting the outermost groove portions of the outer peripheral portion toward the inner peripheral portion.

6. A hydraulic power steering apparatus for a vehicle comprising:
a cylinder tube having a right cylinder and a left cylinder into which a working fluid is supplied and in which a rack bar linearly reciprocates;
a piston moving the rack bar to the right and left sides using the hydraulic pressure of the working fluid supplied into the cylinder tube in which the rack bar is coupled to an inner peripheral portion thereof; and
a piston ring mounted on the outer peripheral portion of the piston and inserted into the inner peripheral surface of the cylinder tube, the piston ring having a plurality of working fluid introducing holes radially formed such that the outer peripheral portion of the piston is communicated with the inner peripheral surface of the cylinder tube.

7. The hydraulic power steering apparatus as claimed in claim 6, wherein a plurality of grooves are radially formed at the outer peripheral portion of the piston.

8. The hydraulic power steering apparatus as claimed in claim 7, wherein the piston ring has a plurality of bosses corresponding to the grooves of the piston.

9. The hydraulic power steering apparatus as claimed in claim 7 or 8, wherein the working fluid introducing holes are radially formed in communication with the outermost grooves of the piston.

10. The hydraulic power steering apparatus as claimed in claim 7 or 8, wherein a plurality of working fluid introducing holes are radially formed in communication with the grooves of the outer peripheral portion of the piston on a side opposite to the side on which the working fluid introducing holes.

11. The hydraulic power steering apparatus as claimed in any one of claims 6 to 8, wherein a slot hole forming an aperture between the piston and the piston ring is provided in an outer peripheral portion of the piston on a side opposite to the side on which the working fluid holes are formed.
